(19) United States
(12) Patent Application Publication
(10) Pub. No.: US 2001/0022029 A1
(43) Pub. Date: Sep. 20, 2001

(54) Cutting device

(76) Inventor: Frank Richard Chapman Vary, Kyogle (AU)

Correspondence Address: DELIO & PETERSON, 121 WHITNEY AVENUE, NEW HAVEN, CT, 06510

(21) Appl. No.: 09/808,617

(22) Filed: Mar. 14, 2001

(30) Foreign Application Priority Data
Mar. 15, 2000 (AU) PQ6259

(51) Int. Cl. B26B 13/00

(52) U.S. Cl. 30/228

(57) ABSTRACT

The invention relates to a device for cutting material such as metal rod. The device comprises a diaphragm type air brake chamber having a wedge mounted to an output shaft of the chamber, a cutting assembly mounted to the air brake chamber, the assembly comprising two pivotally mounted cutting members with opposed blades with the members biased to maintain an opening between the blades, and a handle for gripping the device rearwardly of the cutting assembly. The device is configured so that on actuation of the air brake chamber, the wedge is driven between ends of the cutting members distal the blades to cause the blades to pivot towards each other.

### TECHNICAL FIELD

This invention relates to a cutting device which can be used for shearing lengths of steel rod and the like. In particular, the invention relates to a pneumatically powered cutting device.

### BACKGROUND ART

In building construction and repair, it is frequently necessary to cut lengths of steel rod or like material. This is particularly the case when forming structures from concrete where reinforcing material needs to be cut to size or trimmed after the structure has been formed. Construction and maintenance of rural property buildings and other structures also frequently requires the cutting of steel members such as steel rod.

Steel rod can be cut using a simple tool such as a hacksaw. However, with larger diameter rod this can be a time consuming exercise that requires a fair amount of effort on the part of work person. Power tools such as angle grinders and electric saws with appropriate cutting wheels can also be used to cut steel rod but a reasonable amount of effort is still required on the part of the tool operator. Furthermore, electric cables required for such power tools can be a danger on building sites if accidentally cut.

Steel rod can be quickly cut with lever type bolt cutters. However, this type of cutting device can place a high physical demand on the operator when numerous pieces of steel rod must be cut. This is particularly so when rod of substantial thickness has to be cut.

There is thus a need for a cutting device that can be used for the repetitive cutting of material such as steel rod which requires minimal physical exertion by the operator.

### SUMMARY OF THE INVENTION

The objection of the invention is to provide a cutting device which can be used to cut material such as steel rod and which overcomes the disadvantages of existing tools that can be used for this purpose. A further object of the invention is to provide a cutting device that meets the foregoing object yet can be fabricated from relatively inexpensive components.

In a broad format, the invention provides a cutting device comprising:

a diaphragm type air brake chamber having a wedge mounted to an output shaft of said chamber;

a cutting assembly mounted to said air brake chamber, said assembly comprising two pivotally mounted cutting members with opposed blades, wherein said members are biased to maintain an opening between said blades; and

a handle for gripping said device rearwardly of said cutting assembly;

wherein said device is configured so that on actuation of said air brake chamber, said wedge is driven between ends of said cutting members distal said blades to cause said member blades to pivot towards each other.

The inventor has surprisingly found that a cutting device suitable for use with steel rod and the like can be provided by using an air brake chamber of the diaphragm type to actuate the cutting members of the device. The device thus uses simple components and requires little operator effort beyond the mere holding of the device.

Air brake chambers suitable for use in cutting devices according to the invention typically range from chambers having a diaphragm area of 129 cm² (20 in²) to 232 cm² (36 in²). A cutting device with the smallest air brake chamber in the foregoing range can be used to cut steel rod of up to about 8 mm diameter while a cutting device with a 232 cm² diaphragm air brake chamber can be used to cut rod of up to about 16 mm diameter.

While a standard automotive air brake chamber can be used, a purpose-built diaphragm-type pneumatic activator can be included in devices according to the invention. In this way, an actuator can be fabricated that has a greater plunger travel than conventional air brake chambers. This results in a smaller chamber diameter and thus leads to a more compact device.

The cutting assembly advantageously includes a frame by which the assembly is mounted either directly or indirectly to the air brake chamber and to which the cutting members are pivotally mounted. The cutting members of lever-type bolt cutters can conveniently serve as the cutting members of the cutting assembly. Hence, apart from the cutting assembly frame and the handle, the device of the invention can be assembled from normal stock items of mechanical equipment suppliers and tool suppliers.

To aid movement of the cutting members under the action of the output shaft wedge, a bearing surface can be provided at the point of contact of a surface of the wedge and a cutting member. The bearing surface is advantageously in the form of at least one roller bearing, the axis of which is parallel with the wedge surface. Alternatively, the wedge surface can include a channel in which a roller bearing runs driving actuation of the blades.

Biasing of the cutting members is conveniently by way of two coil springs extending in opposite directions from cutting members to individual anchors. This will be explained in greater detail below. Alternatively, a single coil spring linking the cutting members can provide the biasing. However, any biasing method known to those of skill in the art can be employed.

A connector is included in the device to connect an air supply hose to the air brake chamber. A valve is also provided, typically as part of the connector, to control supply of air to the chamber. Advantageously, the valve is operated by a trigger or push-button.

An air bleed for bleeding air from the air brake chamber can be provided. The air bleed is advantageously included in a connector/valve assembly.

The handle is typically a continuous member that extends from one side of the cutting assembly around the rear of the air brake chamber to the other side of the assembly and advantageously lies is essentially the same plane as the cutting members of the assembly. The position of the handle is such that the device can adopt a balanced condition when held with two hands. The trigger or push-button for the air supply control valve is advantageously positioned near the handle so that it can be contacted by the thumb or another digit of the user. However, it is positioned so that some extension of the thumb or other digit is required. This prevents inadvertent actuation of the valve.

In an alternative form designed for single handed operation, the handle is merely associated with the air brake chamber. This will be explained in detail below.

Devices can include a second handle for two-handed operation. For example, a device can have a first handle that extends from the rear of the air brake chamber—such as a U-shaped or L-shaped member—and a second handle that extends from the cutting assembly. The second handle is thus essentially a hand grip to facilitate a more balanced holding of the device. A device with two handles is particularly suited for use of the device in a horizontal mode.

Devices according to the invention can be configured for use by left-handed or right-handed operators.

Components of cutting devices according to the invention other than those available from commercial sources can be fabricated from any suitable material. Typically, the cutting assembly frame and handle are fabricated from a metal or metal alloy. A preferred material for the handle is aluminium.

In operation, an air supply is connected to the device. The air supply is typically a portable air compressor capable of delivering 650 to 850 kPa. Opening of the air supply valve delivers air to the air brake chamber and air pressure on the diaphragm causes the output shaft to force the wedge between the ends of the cutting members distal the blades. This separation of the distal ends of the cutting members brings the blades together severing anything therebetween. Closure of the air supply valve and pressure on the diaphragm via an internal spring causes retraction of the wedge with the biasing of the cutting members opening the blades. This allows rapid repetition of the cutting cycle. Retraction of the wedge can also be aided by bleeding air from the air brake chamber.

When used for cutting steel rod, the blade edges of the device cutting members advantageously do not touch. This leaves a web of material at the cut which can be broken with light hand pressure. The pivotal mounting of the blade members can be adjustable to allow a desired gap between the blades to be set.

So that the invention can be more fully understood, specific embodiments will be described below with reference to the accompanying drawings briefly described hereafter.

### BRIEF DESCRIPTION OF THE DRAWINGS

FIG. 1 is a plan view of a cutting device according to the invention.

FIG. 2 is a view of the device of FIG. 1 in use.

FIG. 3 is a plan view of an alternative device according to the invention.

FIG. 4 is a plan view of yet another device according to the invention.

### DESCRIPTION OF PREFERRED EMBODIMENTS

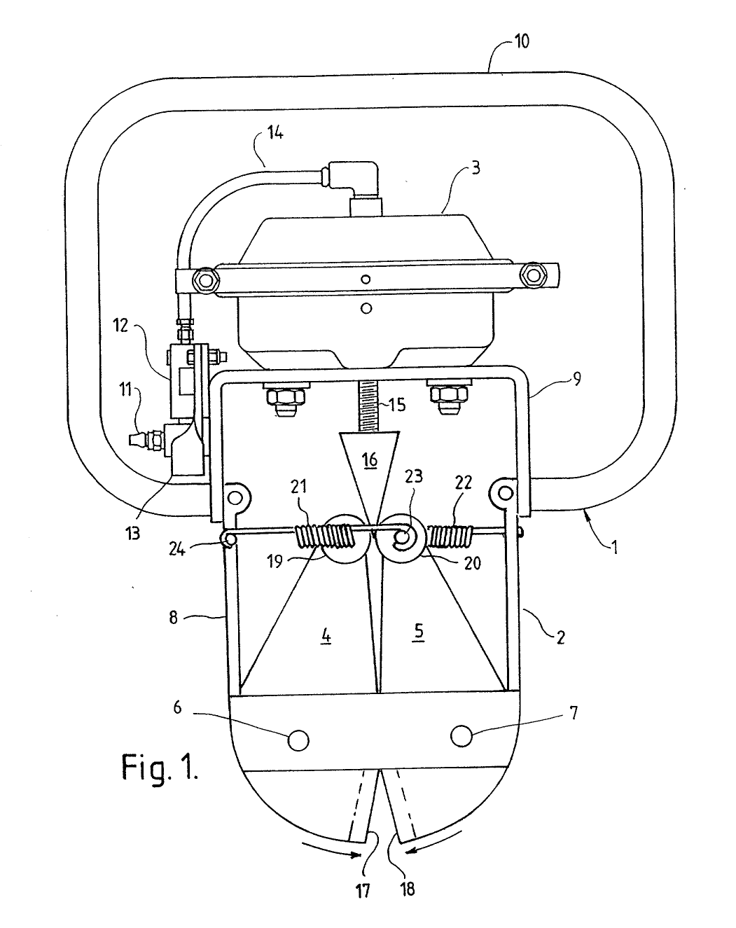

In FIG. 1, there is shown cutting device 1 comprising cutting assembly 2 and air brake chamber 3. Cutting assembly 2 consists of cutting members 4 and 5 pivotally mounted at 6 and 7 into a frame 8 which is mounted via brake 9 to air brake chamber 3. A handle 10 extends around the air brake chamber from either side of the bracket. Device 1 further includes a connector 11 associated with a valve 12 operated by trigger 13. Valve 12 is connected to air brake chamber 3 by hose 14. Connector 11 is for connection of a hose from a supply of compressed air. Output shaft 15 of air brake chamber 3 has wedge 16 fitted thereto.

With further reference to cutting assembly 2, each cutting member can be seen to have a blade 17 or 18 which are depicted in the open position. The ends of the cutting members distal the blades have roller bearings on each face thereof, the upper bearings in FIG. 1 being indicated at 19 and 20. It can be seen that the point of the wedge rests between the roller bearings when the blades are open.

Biasing of cutting members 4 and 5 is by way of coil springs 21 and 22 on either side of cutting assembly 2. With reference to the upper spring in the figure, item 21, this is connected to axle 23 for the roller bearings on cutting member 5 and at the other end to pin 24 on frame 8. Spring 22 is similarly connected between the distal end of cutting member 4 and the opposite side of the frame. It will be appreciated that since the springs urge the distal ends of the cutting members together when wedge 16 is in the position shown in FIG. 1, blades 17 and 18 are opened.

Cutting action is effected by supplying air to air brake chamber 3 which forces wedge 16 between the bearings at the distal ends of cutting members 4 and 5 which moves blades 17 and 18 together as indicated by the arrows below the cutting members. On retraction of wedge 16, blades 17 and 18 are returned to the positions shown in FIG. 1 by the action of springs 21 and 22.

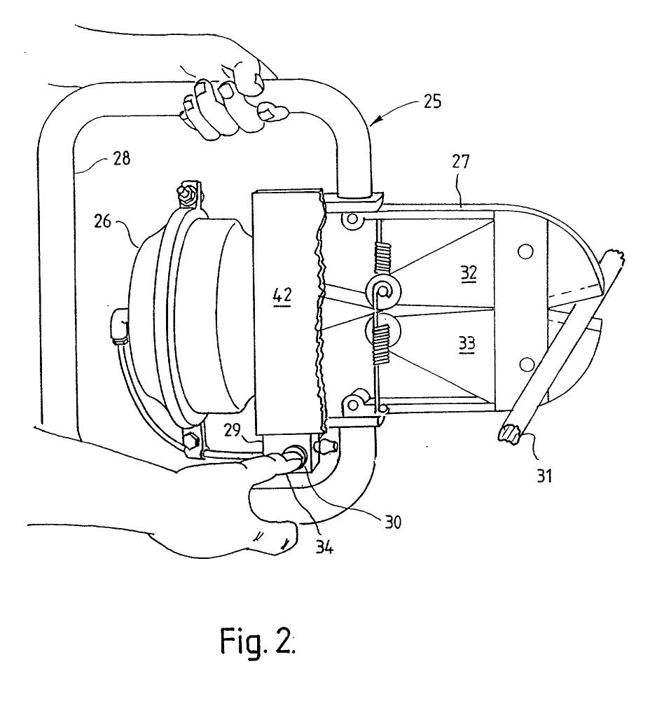

FIG. 2 shows essentially the same cutting device 25 depicted in FIG. 1 in that it comprises air brake chamber 26, cutting assembly 27 and handle 28. However, rather than having a trigger to operate valve 29, device 25 has a push button 30.

FIG. 2 shows how device 25 is held by both hands of the operator. Steel rod 31 is shown between the blades of cutting members 32 and 33. The figure also shows that extension of thumb 34 of the operator is necessary to actuate valve 29, as normally the thumb would be curled around handle 28.

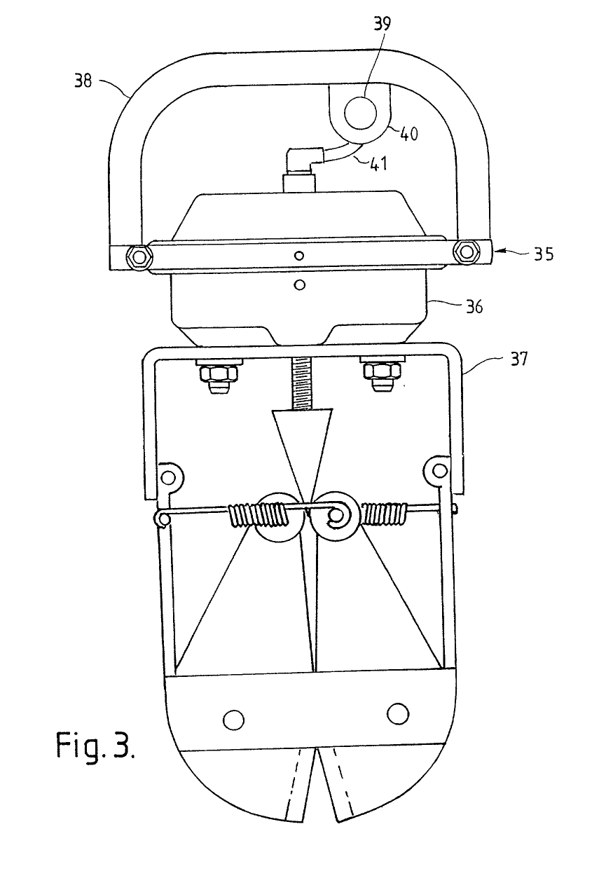

An alternative configuration of a cutting device according to the invention is shown in FIG. 3. Cutting device 35 includes the same air brake chamber 36 and cutting assembly 37 as the devices of FIGS. 1 and 2. However, handle 38 is a simple U-shaped member associated with the air brake chamber. A push button 39 and associated valve (not visible in the figure) is attached to a plate 40 extending inwardly of the handle. The valve is connected to air brake chamber 36 via hose 41 and also includes a connector for receiving an air supply hose.

Cutting device 35 is intended for single handed use with the hand of the operator positioned adjacent push-button 39. It will be appreciated from FIG. 3 that device 35 is primarily intended for vertical use with the cutting members downward.

Cutting devices as shown in FIGS. 1 to 3 can further include cover plates over the output shaft and wedge contact areas of the cutting members as safety and protective measures. Portion of a cover plate is shown as item 42 of FIG. 2.

In a further variant, a cutting device as shown in FIGS. 1 and 2 can include two air control valves, one as indicated in the figures and one as indicated in FIG. 3. Such a device can be used with two hands as shown in FIG. 2 or with one hand according to the FIG. 3 device.

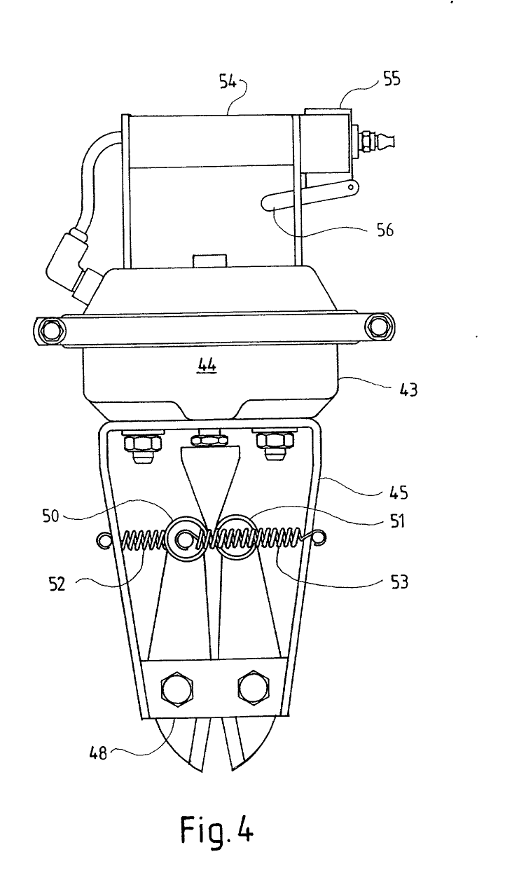

Turning to FIG. 4, a more compact cutting device is depicted. Cutting device 43 has an air brake chamber 44 having a diaphragm area of 129 cm² (20 in²). Chamber 44 has a frame 45 connected thereto for carrying cutting members 46 and 47 which are pivotally mounted to cross-piece 48. Wedge 49 at the free end of the plunger (not visible in the figure) of chamber 44 extends between paired roller bearings at the distal ends 50 and 51 of cutting members 46 and 47, respectively. The distal ends are biased towards each other by counter-acting springs 52 and 53.

Device 43 has a simple handle 54 which extends from the rear face of air brake chamber 43. Actuating valve 55 is operated by a lever-type trigger 56. Other features of device 43 are essentially the same as the devices shown in other figures.

The device shown in FIG. 4 is designed for single-handed operation and is particularly suited for vertical operation with the cutting members directed downwards. Device 43 advantageously has moulded or cast cover sections thereabout so that the only portions of the device uncovered are the blades of the cutting members and the handle. Such covers can be used with the devices of the other figures.

It will be appreciated that many changes can be made to the cutting devices as exemplified above without departing from the broad ambit and scope of the invention.

I claim:

1. A cutting device comprising:
a diaphragm type air brake chamber having a wedge mounted to an output shaft of said chamber;
a cutting assembly mounted to said air brake chamber, said assembly comprising two pivotally mounted cutting members with opposed blades, wherein said members are biased to maintain an opening between said blades; and
a handle for gripping said device rearwardly of said cutting assembly;
wherein said device is configured so that on actuation of said air brake chamber, said wedge is driven between ends of said cutting members distal said blades to cause said member blades to pivot towards each other.

2. The device according to claim 1, wherein said air brake chamber has a diaphragm area of 129 cm² (20 m²) to 232 cm² (36 in²).

3. The device according to claim 1, wherein said cutting assembly includes a frame by which the assembly is mounted directly or indirectly to said air brake chamber.

4. The device according to claim 1, wherein a bearing surface is provided between the point of contact of a surface of said wedge and a cutting member.

5. The device according to claim 4, wherein said bearing surface comprises at least one roller bearing.

6. The device according to claim 1, wherein biasing of said cutting members is by way of coil springs extending in opposite directions from said distal ends of said cutting members to the mounting therefor.

7. The device according to any one of claim 1, wherein biasing of said cutting members is by at least one spring linking said distal ends of said cutting members.

8. The device according to claim 1, wherein said handle comprises a continuous member extending from one side of said cutting assembly around the rear of said air brake chamber to the other side of said cutting assembly and lies in essentially the same plane as said cutting members.

9. The device according to any one of claim 1, wherein said handle comprises a substantially U-shaped member extending rearwardly of said air brake chamber and substantially in the same plane as said cutting members.

10. The device according to claim I comprising first and second handles.

11. The device according to claim 10, wherein said first handle extends rearwardly of said air brake chamber and said second handle extends laterally of said cutting assembly.

12. The device according to claim 1, wherein at least one valve is provided to control supply of air to said air brake chamber and said valve is operated by a trigger or push-button adjacent said handle.

13. The device according to claim 1, wherein portions of said device other than said blades of said cutting members and said handle are covered.

14. A cutting device comprising:
a diaphragm type air brake chamber having a wedge mounted to an output shaft of said chamber;
a cutting assembly mounted to said air brake chamber via a frame, said assembly comprising two pivotally mounted cutting members with opposed blades, wherein said members are biased to maintain an opening between said blades with said biasing by way of coil springs extending in opposite directions from distal ends of said cutting members to said frame; and
a handle for gripping said device rearwardly of said cutting assembly, said handle having adjacent thereto a valve for controlling flow of air to said chamber;
wherein said device is configured so that on actuation of said air brake chamber, said wedge is driven between roller bearings mounted at said distal ends of said cutting members to cause said blades to pivot towards each other.
